(19) United States
(12) Patent Application Publication
(10) Pub. No.: US 2010/0179690 A1
(43) Pub. Date: Jul. 15, 2010

(54) PROCESS CONTROL, SYSTEM, AND METHOD FOR THE AUTOMATED ADAPTATION OF PROCESS PARAMETERS OF AT LEAST ONE HANDLING DEVICE

(75) Inventors: Bjoern Matthias, Bad Schoenborn (DE); Roland Krieger, Ladenburg (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: ABB RESEARCH LTD., Zurich (CH)

(21) Appl. No.: 12/664,126

(22) PCT Filed: Jun. 2, 2008
(86) PCT No.: PCT/EP08/04367

§ 371 Date: Dec. 11, 2009

(30) Foreign Application Priority Data
Jun. 15, 2007 (DE) 10 2007 028 390.5

(51) Int. Cl. B25J 13/08; G05B 13/02; B25J 9/16; B25J 18/04

(52) U.S. Cl. 700/253; 700/8; 700/79; 700/255; 901/6; 901/46; 901/49

(57) ABSTRACT

A system for automated adaption of a process parameter of a handling device includes a supervision device configured to selectively monitor at least one process parameter and/or to adapt the at least one process parameter of the handling device in an automated manner based on specifications and/or the environment and/or in a rule-based manner in interaction with a control/regulation device, wherein environment/safety-specific specifications and/or regulations are complied with and/or implemented irrespective of the type of a respective working process, wherein the system is configured to interact with the control/regulation device configured to monitor, control and/or regulate the handling device.

This is a U.S. National Phase Application under 35 U.S.C.§371 of International Application No. PCT/EP2008/004367, filed on Jun. 2, 2008, which claims priority to German Application No. DE 10 2007 028 390.5, filed on Jun. 15, 2007. The International Publication was published in German on Dec. 18, 2008 as WO 2008/151739 under PCT article 21 (2).

The invention relates to a system and a method for the automated adaptation of process parameters of at least one handling device, in particular at least one robot which can be used in industry and preferably has six axles. Furthermore, the invention relates to a process controller having the abovementioned system.

### BACKGROUND

The progressive fusion of the working areas of man and machine and the associated intensification in man-machine cooperation places ever greater safety requirements on modern automation systems, which must be taken into account using more and more comprehensive and reliable but also generally more complex safety concepts.

New production concepts and working environments which allow man to be incorporated as an integral part of the respective production and/or working process are possible, not least as a result of the integration of appropriate safety concepts in the respective production systems and/or processes and, in particular, as a result of the availability of powerful control/regulation devices with corresponding safety devices, also with so-called “safety controllers”, for monitoring and controlling and/or regulating, in particular, industrial robots with a plurality of axles.

In this case, simply configured production concepts and/or working environments provide, for example with respect to design, dimensioning and use/application, rigidly or permanently specified working and/or production cells with corresponding separating grids and/or fences, walls or other physical demarcations which effect and maintain strict separation between the working areas of man and machine, in particular a robot.

However, these concepts are increasingly being superseded by working environments which can be used in a more and more flexible manner, in particular working cells with more powerful and more flexible safety concepts with, for example, safety devices such as “safety controllers”, roller doors or gates (so-called “shutter gates”), laser scanners, light curtains, light barriers, motion detectors, infrared detectors, radar monitoring, safety PLCs and other such devices, in order to enable man and machine, in particular a robot, to interact closely but also, at the same time, in a safe or harmless manner, and to allow better use to be made of synergy effects.

In this case, essentially two main requirements are imposed on the respective working process when using the abovementioned safety concepts. On the one hand, said process must be adapted to the safety requirements and/or regulations and/or concepts of the respective working environment, in particular a working cell which has been set up in an appropriate manner; this means that each process must be individually developed and adjusted in order to meet the safety requirements and/or specifications of the respective working cell. In this case, the programmer or developer also has to take into account, inter alia, those areas and/or zones which the robot must not cross and/or enter under particular conditions as well as areas and/or zones in which the robot can move only at a reduced speed and/or conditions which make it necessary for the robot to remain in position and/or to move to a predetermined position and/or to stand still and not move.

For example, the robot should only move slowly into or through an area when a person is in the abovementioned area or in the immediate vicinity of this area and, for example, is waiting for a workpiece for acceptance.

Furthermore, a robot shall no longer move or should remain in position when it receives a workpiece through an access which can be closed, for example a roller gate or a roller door, and the access is open.

In this case, it is absolutely essential to take into account all safety requirements in order to avoid, as far as possible, process-related violation of given safety regulations and/or limits in order to ultimately avoid being stopped by the superordinate safety system, which would result in the process being terminated or at least interrupted.

However, the abovementioned measures—process adaptations and/or the process of taking into account all safety requirements—can mean a considerable amount of additional effort in comparison with the implementation of the same process without accordingly taking into account the safety requirements.

In addition, each individual process must secondly be tested in order to determine whether it complies with the set safety requirements and the respective rules. Accordingly, after a process has been implemented, it is necessary to accordingly initiate and run through test procedures or methods which detect and cover each individual section of a production and/or working cycle or process. Accordingly, it is also necessary to run through a multiplicity of different tests so that it can be ensured that all safety requirements and/or rules or guidelines have been complied with.

Although this means an immense expenditure—of the technical kind but also ultimately in terms of time and costs, only in this manner is it possible to ensure that the respective process is running within the set specification and stipulation and no unexpected violations or breaches of predetermined safety margins and/or rules occur. In the worst case, these could also result in the superordinate safety system initiating an emergency stop or emergency shutdown of the respective process and thus also a shutdown of one or more handling devices used.

Therefore, each process must disadvantageously be manually adapted to the respective working cell and the specified safety requirements and/or rules with a considerable amount of effort. Corresponding automation of the abovementioned process has hitherto not been possible.

In addition, it is not possible to operate flexibly adaptable working cells for the purpose of also carrying out different working processes under identical safety concepts with identical safety requirements or specifications or rules since each individual process would have to be adjusted to comply with the identical/same set of safety regulations/specifications and/or rules. In addition, each process would also have to be tested for fulfillment of and/or compliance with the corresponding regulations, specifications and/or rules, which would mean an immense technical and temporal expenditure.

This applies, in particular, in the face of more complex cell superstructures with at least one additional machine tool and/or workpiece machining, for example, and/or when using two or more handling devices in only one cell, the two handling devices having to be matched to one another if present and/or device-specific specifications and/or requirements—also of a safety-related nature—having to be taken into account.

### SUMMARY OF THE INVENTION

Therefore, an aspect of the present invention is to provide a simplified and improved possibility for matching a working process to a working environment, in particular in a safety-related manner, at least one handling device being provided in order to carry out the process.

The inventive system for the automated adaptation of process parameters of at least one handling device interacts with at least one control/regulation device, in particular with a safety controller, for monitoring and/or controlling and/or regulating the at least one handling device, provision being made of at least one supervision device which selectively monitors at least one process parameter and/or, if necessary, adapts at least one process parameter of the at least one handling device in an automated manner on the basis of specifications and/or the environment and/or in a rule-based manner in interaction with the at least one control/regulation device, environment-specific and/or safety-specific specifications and/or regulations also being complied with and/or implemented irrespective of the type of the respective working process.

In one advantageous development of the system, the at least one process parameter is adapted in an anticipatory manner.

In one system refinement, provision can be made of at least one interface which makes it possible to detect and/or determine ambient information, in particular sensor and/or switching and/or state information of operating means and/or monitoring devices used, for example the opening and/or closing of gates, the triggering/signaling of light barriers and the like.

In this case, the system can provide for the design and/or the structure of at least one working cell in which one or more handling devices can be arranged to be detected and/or used as a basis as the working environment, different working and/or safety areas, light barriers, layout and/or subdivision of the respective working cell, zones with different speeds, for example, workstations of the handling device, gates and the like also being able to be detected, in particular.

Another advantageous refinement of the system provides for the at least one process parameter of the at least one handling device to be adapted on the basis of the position and/or alignment of the at least one handling device.

If more than only one handling device is used, provision can advantageously be made for the at least one process parameter of at least one handling device to also be adapted on the basis of or taking into account the position and/or alignment and/or speed of the respective other handling devices and/or for the adaptation to be effected in a coordinated manner.

In one system development, provision is made of at least one interface which enables predetermined process information to be detected by and/or transmitted to the control/regulation device. The at least one interface may be wireless in this case, for example may be in the form of a WLAN, Bluetooth, IR or GPRS interface, or may be wired, for example may be in the form of a PCI, SCSI, Firewire, LAN, Ethernet, USB or RS-232 interface. Corresponding field bus interfaces, for example PROFIBUS, CAN bus or field bus foundation can also be advantageously provided.

One development of the system provides for the supervision device of the at least one handling device to detect position and/or ambient information continuously or cyclically or continuously in recurring intervals of time, to evaluate said information and to use it to determine and/or adapt parameters.

In this case, the position information can be detected in interaction with the control/regulation device and/or the safety controller, in particular by reading sensors, signal transmitters, limit switches as well as axle positions, articulation positions and/or current/voltage values of the drive units for the respective handling device.

In another advantageous refinement, the system has at least one data memory in which process information and/or ambient information and/or instructions is/are stored, in particular in the form of program code means, both for the control/regulation device and for the supervision device in such a manner that it/they can be retrieved and/or executed.

In another refinement, the control/regulation device comprises at least one data processing device which interacts with the at least one data memory containing process information and/or instructions, in particular in the form of program code means, for carrying out and/or implementing the respective working process for the handling device.

In another refinement, the supervision device can be integrated in the control/regulation device and/or, in particular, is in the form of an insertion element.

In an advantageous refinement, the supervision device comprises a data processing device, in particular a microprocessor and/or a PLC, and/or a data memory.

In particular, the respective instructions and/or movement patterns/patterns of action are determined in this case solely by the respective working process and/or do not comprise and/or take into account virtually any environment-specific specifications.

A development of the system may provide for the supervision device to adapt the at least one process parameter of the at least one handling device dynamically, that is to say even in the case of changing ambient conditions and/or ambient information, for example changes in switching states, changing sensor and/or position information, in particular of other handling devices and the like as well.

Provision may also be advantageously made for the supervision device to effect the adaptation of the at least one process parameter, that is to say the change from an actual value to a desired value, on the basis of the environment and/or specifications using a continuous function, in particular having a linear, parabolic, exponential or logarithmic profile, or using a step function.

A system refinement provides for the supervision device to adapt, as at least one process parameter, the speed and/or at least one speed component and/or the orientation and/or the alignment and/or the position of the at least one handling device and/or the tool of the latter.

Provision may also be made for the supervision device to adapt the at least one process parameter online, that is to say during continuous operation of the handling device during the respective process execution.

In another refinement, provision is made of a safety device, in particular a superordinate safety device, which effects an emergency shutdown of the system, in particular of the at least one handling device, if predetermined safety rules are violated and/or there are deviations from parameter specifications outside predetermined limits, supervision devices and safety devices acting independently of one another and not influencing one another.

Provision may also be made for supervision devices and safety devices to interact in such a manner that ambient information and/or environment-specific specifications and/or characteristic variables recorded in the safety device can be retrieved by the supervision device and/or can be used to adapt parameters.

In an advantageous development of the system, at least one handling device is in the form of an industrial robot, in particular an industrial robot having six axles and/or articulations.

Provision may also be made for at least one handling device to be a grinding, welding or painting robot or a robot with a gripping tool or another tool.

A process controller for controlling/regulating at least one handling device for carrying out a working process is also claimed, which process controller achieves the stated object and comprises a control/regulation device and a safety controller as well as a system for the automated adaptation of process parameters of at least one handling device.

One refinement of the process controller provides for process-specific movement patterns created with a planning tool, in particular a “motion planner”, and/or corresponding instructions for the at least one handling device to be able to be transmitted to and/or impressed on the control/regulation device for implementation and/or execution.

Furthermore, provision may advantageously be made of at least one interface which enables predetermined process information to be detected by and/or transmitted to the control/regulation device and/or enables sensor and/or state information of operating means used as well to be detected and processed.

In this case, the at least one interface may be wireless, in particular may be in the form of a WLAN, Bluetooth, IR or GPRS interface, or may be wired, in particular may be in the form of a PCI, SCSI, Firewire, LAN, Ethernet, USB or RS-232 interface, or else may be in the form of a field bus interface, in particular in the form of a PROFIBUS or CAN bus interface.

The above-described system, the process controller and the corresponding method make it possible to match a working process to a respectively specified working environment in an automated and/or continuous manner whilst incorporating at least one handling device and with comparatively little effort.

The invention as well as advantageous refinements and developments are explained further using some drawings and exemplary embodiments.

### BRIEF DESCRIPTION OF THE DRAWINGS

In the drawings:

FIG. 1 shows a working cell which is designed by way of example and has different working areas and zones,

FIG. 2 shows an idealized process in a working cell which is designed by way of example,

FIGS. 3a, b show the design and dependence of a conventional process controller,

FIG. 4 shows a conventional process controller having a control/regulation device with a safety controller for at least one handling device,

FIG. 5 shows a conventional process sequence in a working cell which is designed by way of example,

FIGS. 6a, b show the design and dependences of a process controller having a system for the automated adaptation of process parameters of at least one handling device,

FIG. 7 shows a process controller having a system which is designed by way of example for the automated adaptation of process parameters of at least one handling device,

FIG. 8 shows a process sequence according to the method for the automated adaptation of process parameters of at least one handling device.

### DETAILED DESCRIPTION

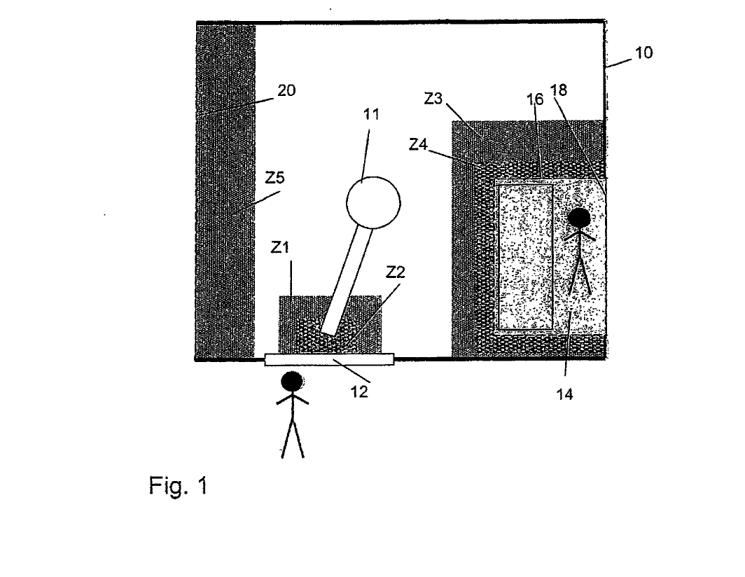

FIG. 1 indicates a working cell 10 which is designed by way of example and has at least one handling device 11, in particular a six-axle industrial robot, as well as an area which is intended to manually supply workpieces and has a roller gate 12, and a manual working area 14, for example for removing workpieces. The manual working area 14 is separated from the inner area 15 of the working cell by means of a first light curtain 16, in particular one or more light barriers and/or laser scanners, and is separated from the outer area of the cell by means of a second light curtain 18, in particular one or more light barriers and/or laser scanners. In this case, the area which is intended to manually supply workpieces and has a roller gate 12 can be subdivided into a first safety-relevant zone Z1 and a second safety-relevant zone Z2. Two safety-relevant zones are also provided around the manual working area 14, namely a third zone Z3 and a fourth zone Z4. A third light curtain 20 which delimits the cell 10 to the left-hand side (left-hand side in a plan view of FIG. 1) toward the outer area around the working cell is additionally provided. Starting from this third light curtain 20 is a further, fifth safety-relevant zone Z5 which is directed into the interior of the cell.

In this case, different process specifications and/or process parameter specifications and/or conditions for the handling device as well as associated safety regulations which must be complied with can be defined and/or specified for the different areas 12, 14, 15 and/or zones Z1, Z2, Z3, Z4, Z5. These are generally aimed at preventing hazards and, in particular, damage to the machine and/or injuries to people and at enabling safe interaction as well as a safe process sequence which is as smooth and trouble-free as possible. For example, it may be specified that the handling device 11, in particular a 6-axle robot, moves only at a reduced speed in selected zones under particular ambient conditions and/or specifications such as, in particular, gate 12 open or closed, person present or absent, further robot in the immediate vicinity and the like. In the example shown here, this applies to the first zone Z1 if the gate 12 is open, and to the third zone Z3 if a person, in particular a worker, technician or engineer, is inside the manual working area 14, and also to the fifth zone Z5 since it is in the immediate vicinity of the outer area. The respectively prevailing ambient conditions can be ascertained and/or determined using corresponding ambient information such as switching states of operating means used, sensor and/or monitoring information.

It may also be specified that the respective robot 11 or the respective process is stopped or switched off if the robot 11 moves into other selected zones, in this case the second zone Z2 if the gate 12 is open and the fourth zone Z4 if a person is present in the manual working area 14.

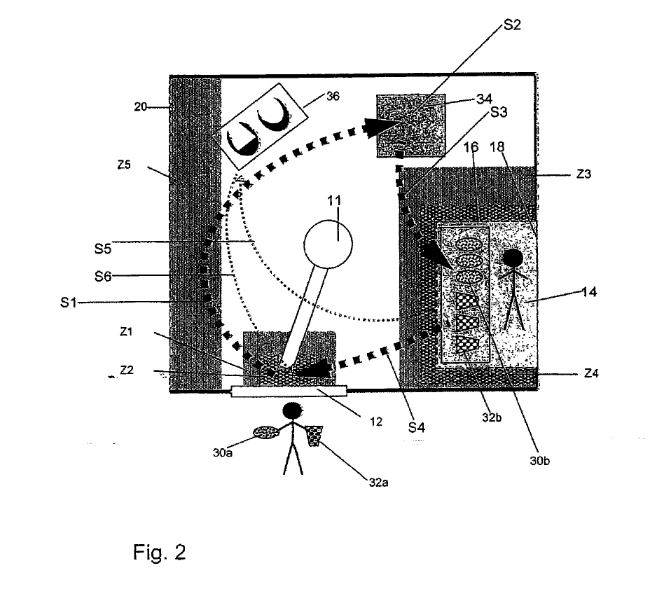

FIG. 2 shows an idealized sequence of a working process in a working cell which is designed by way of example and, in addition to FIG. 1, also comprises a station for changing tools 36 and workpiece machining 34. In the abovementioned working process, different workpieces 30a, 32a to be machined are manually passed into the working or production cell 10 through a roller gate 12 which can be opened and closed. According to the process, the workpieces 30a, 32a which have been introduced should be detected, picked up and passed, in a first step S1, to a machining station 34, for example a machine tool/processing machine 34 for further machining and/or processing, by at least one handling device 11. In order to be able to also pick up and handle geometrically different workpieces, a tool changer or a station for changing tools 36 is provided in the working cell for the handling device 11, which tool changer makes it possible, for example, to select and apply different gripping tools depending on requirements and/or the workpieces.

In a second step S2, the respective workpiece 30a, 32a should then be machined and, in a step S3, the machined workpieces 30b, 32b should then be again detected, picked up and passed to the manual working area 14 for manual removal, further machining and/or processing and/or supervision. In a fourth step S4, the handling device 11, now without a workpiece 30a, 32a, then moves back to the gate 12 in order to pick up the next workpiece. If a tool change were necessary before picking up the next workpiece, the handling device 11 would, as an alternative to the fourth step S4, move to the changing station in a first alternative step S5, would change the tool and would move back to the gate 12 in a further alternative step S6.

The movement paths of the handling device 11 which correspond to the individual steps S1, S3, S4, S5, S6 are marked by arrows.

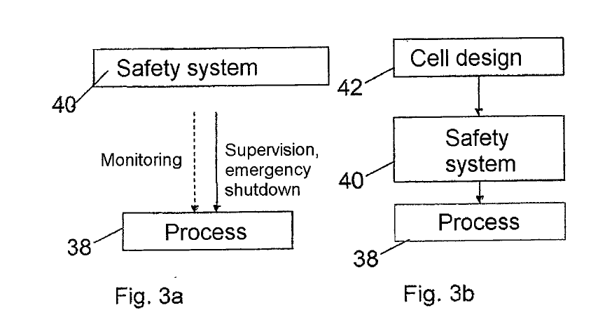

FIG. 3a shows the design of a conventional process controller for a production or working cell 10 which is designed by way of example. In this case, the respective working process 38, for example the assembly of a product comprising different workpieces, intermediate products or components, the further processing of a workpiece, and the production and/or handling of a workpiece, and thus also the movements of the at least one handling device 11 are generally monitored and supervised by a safety system 40 or a safety-related system. In this case, the respective working process 38 is monitored and supervised to the effect that the safety system 40 is set up to detect when predetermined safety rules and/or process specifications or process-relevant parameters and/or conditions are not complied with or are disregarded and, in the event of violation, to immediately effect an emergency shutdown or termination of the respective working process 38.

In order to achieve this, particular dependences and/or links need to be taken into account, as indicated in FIG. 3b. The safety system 40 should thus always be designed and/or set up on the basis of the respective working environment or the respective cell design 42. Furthermore, each working process 38 should be individually designed or adapted to the effect that it takes into account and/or complies with the safety rules and/or requirements and/or specifications and/or conditions specified by the safety system 40 and thus also the cell design 42, for example location-dependent speed restrictions, restrictions in the freedom of movement of the handling device or tool specifications, with the result that an incident is generally avoided.

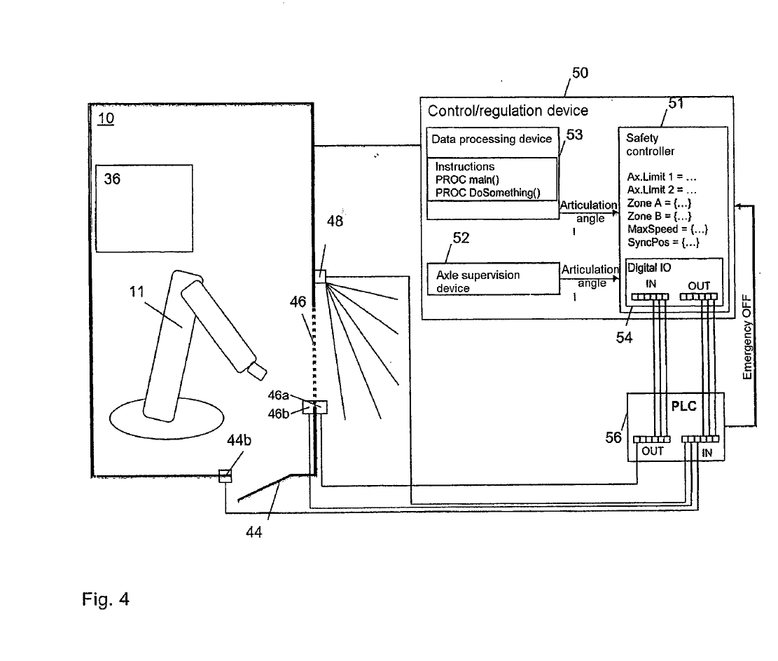

FIG. 4 shows a conventional process controller which is used to implement a process—in the example shown here to implement the working process essentially known from FIG. 2 using a working cell 10 with a handling device 11, workpiece machining 36, a door 44 with a switch 44b, a roller door 46 with a drive 46a with a switch 46b and a laser scanner 48 for monitoring the environment thereof—and has a control/regulation device 50 with a safety controller 51 for at least one handling device. The control/regulation device 50 also comprises an axle supervision device 52 for detecting and supervising the articulation angle, the axle and/or tool position and/or the alignment of the handling device 11. The control/regulation device 50 also comprises a data processing device 53 which, in interaction with a data memory (not explicitly illustrated in FIG. 4), transmits predetermined instructions for carrying out and implementing the respective working process 38 to the handling device 11. In interaction with the data processing device 53 and the axle supervision device 52, the respective articulation and/or axle angles determined using the data processing device 53 and the axle supervision device 52 are compared with one another and/or matched to one another at predetermined synchronization positions using the safety controller 51, and the respective position and alignment of the handling device 11 are thus checked and corrected, if necessary.

If limit values of individual process parameters and/or process specifications for particular areas and/or zones of the working cell, as specified by the safety controller, are exceeded or undershot in this case, the safety controller initiates an emergency shutdown of the control/regulation device 50 or the handling device 11 in interaction with a programmable logic controller (PLC) 56. Furthermore, the PLC interacts with different monitoring devices, for example limit switches and light barriers, in order to retrieve and evaluate additional ambient information. Depending on the specifications, an emergency shutdown can thus also be initiated, for example, when the door 44 to the working cell 10 is open, which is detected by the switch 44b, or when a person is in the detection range of the laser scanner 48.

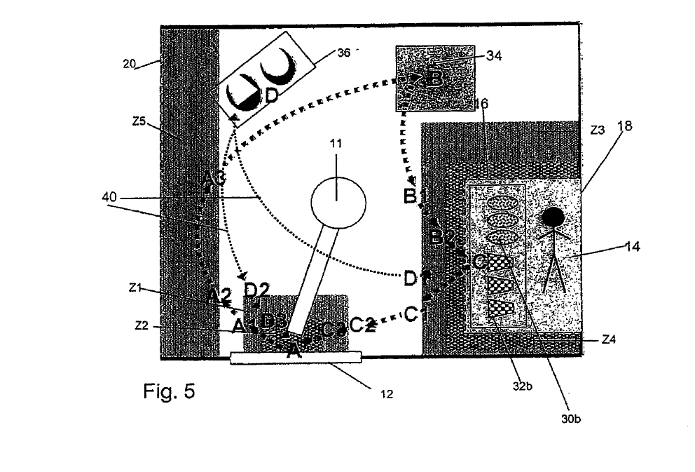

FIG. 5 shows a process sequence of the idealized process according to FIG. 2, which process sequence is implemented using a conventional control/regulation device 50 with a safety controller 51. Corresponding instructions for the handling device 11 in the form of program code means for implementation and/or execution by the process controller and handling device 11 are indicated by way of example below:

//Initial state: robot at A, gate open

| | |
|---|---|
| • | WHILE true DO |

- pick up work piece;
- close gate;
- WAIT UNTIL gate closed;
- set speed = slow;
- move to A1;
- set speed = high;
- move to A2;
- set speed = low;
- move to A3;
- set speed = high;
- move to B;
- process work piece;
- move to B1;
- set speed = low;
- move to B2;
- WAIT UNTIL no worker present;
- move to C;
- put down work piece;
- IF next work piece NOT same as current

| | |
|---|---|
| • | move to D1; |
| • | set speed = high; |
| • | move to D; |
| • | change tool; |
| • | move to D2; |
| • | set speed = low; |
| • | move to D3; |

-ELSE

| | |
|---|---|
| • | move to C1; |
| • | set speed = high; |
| • | move to C2; |
| • | set speed = low; |
| • | move to C3; |

| | - ENDIF |
|---|---|
| | - move to A; |
| | - open gate; |
| • | ENDWHILE |

According to the above instructions, the idealized process according to FIG. 2 can be conventionally implemented by the following process sequence.

The process begins at starting point A, the gate 12, if the latter is open. If the handling device 11, in particular the robot, is at the starting point A and the gate 12 is open (ideal starting situation), said robot should, if these prerequisites exist at the beginning, pick up a first workpiece 30a, close the gate, wait until the gate 12 is closed and should then move, at a slow speed, through Z2 from A to A1, should then move, if the door is closed, at a high speed from A1 to A2, should then move, at a slow speed, through Z1 from A2 to A3, should then move, at a high speed, from A3 to B, should machine the workpiece 30a which has been picked up at B, should then move, still at a high speed, with the machined workpiece 30b to B1, should then move, at a low speed, through Z3 from B1 to B2, should remain or wait at B2 until no person or worker is present in the respective manual working area 14, should then slowly move through Z4 to C and should deposit the machined workpiece 30b. Before the next workpiece 30a, 32a can now be picked up, it is necessary to check whether or not the subsequent workpiece 30a, 32a corresponds to the previous workpiece; two alternatives therefore result.

1. The next, second workpiece 32a to be handled differs from the previous first workpiece 30a, with the result that a tool change is first of all required in order to handle said second workpiece. The handling device 11 therefore first of all moves slowly through the zones Z4 and Z3 from C to D1, then moves, at a high speed, from D1 to D, changes the tool at D, then moves, at a high speed, from D to D2 and then moves, at a slow speed, through zone Z1 from D2 to D3.

2. The next, second workpiece 30a to be handled is identical to the previous workpiece, with the result that no tool change is required in order to handle said second workpiece. The robot therefore moves, at a slow speed, through the zones Z4 and Z3 from C to C1, then moves, at a high speed, from C1 to C2 and then moves, at a slow speed, through zone Z1 from C2 to C3.

Starting from D3 or C3, the robot then moves, at a slow speed, through zone Z2 to the starting point A and opens the gate 12 in order to pick up the next workpiece, for example, or the above-described sequence begins again.

Furthermore, it could also be predetermined, for example, that the handling device 11 remains at C3 or D3, that is to say does not move into zone Z1, as long as the gate 12 is open.

If one of the set specifications or regulations is violated, for example because the robot incorrectly moves too quickly in a zone or, for example, does not remain at a position for long enough according to the process, this inevitably results in intervention by the safety controller 51 and in a shutdown of the handling device 11 and thus an interruption in the process.

It is clear from this that every safety regulation and/or specification, however minor, must be individually taken into account in the respective process or in the movement pattern on which the latter is based and the process must be adapted to that effect, which can be achieved only with a considerable amount of effort in the case of a multiplicity of different processes or even the rearrangement of processes and/or modernization.

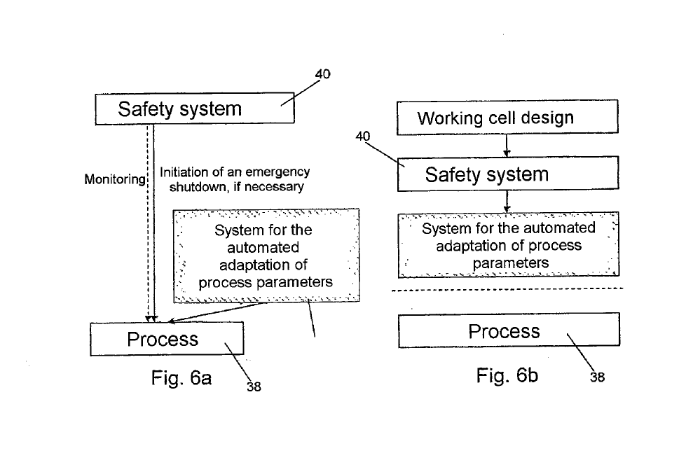

FIG. 6a shows the design of a process controller having a system which is designed by way of example for the automated adaptation of process parameters of a handling device 11.

In this case, the respective working process, for example the assembly of a product comprising different workpieces, intermediate products or components, the further processing or machining of a workpiece and the production and/or handling of a workpiece, and thus also the movement of the at least one handling device 11 are monitored and controlled by a safety system 40 or a safety-related system. Monitoring and control by the safety system 40 are carried out to the effect that the safety system 40 detects when predetermined process specifications, in particular also safety-critical or safety-relevant regulations and/or conditions, are violated or disregarded and, in the event of violation, immediately initiates and/or effects an emergency shutdown or termination of the respective working process 38.

In addition to the abovementioned safety system 40, a system for automated process adaptation is provided, which system, in the case of potential or imminent conflicts and/or critical situations, that is to say in the case of imminent violation of specifications, in particular safety-related specifications, adapts the at least one critical process parameter of the handling device 11, for example position coordinates, alignment, speed and the like, in an anticipatory manner, that is to say before such a conflict occurs, in automated fashion on the basis of specifications and/or the environment and/or in a rule-based manner in order to avoid or prevent the imminent conflict and therefore ultimately a shutdown or interruption of the respective process by the safety system 40.

In order to achieve this, given dependences must also be taken into account here, as shown in FIG. 6b. The safety system 40 and the system for the automated adaptation of process parameters should thus always be designed and/or set up on the basis of the respective cell design or the respective cell architecture, safety-related parameter specifications and/or regulations being able to be adopted by the safety system during access to the latter.

In addition, however, there is no longer any need for preparatory individual adaptation of the respective working process 38 to the respective working environment, in particular the working cell, and thus also the respective cell architecture, as well as with the design since the system and the method for the automated adaptation of process parameters ensure that no safety violations and/or disturbances occur by continuously monitoring different relevant process parameters, for example speed and/or position and/or articulation angle and/or axle position, during the ongoing process and adapting them to given specification values and/or parameter specifications, also safety-related specifications, for example speed restrictions, zones which are prohibited for the handling device 11 and the like, in an anticipatory manner before a conflict occurs, with the result that conflicts and intervention by the safety system 40 are avoided as far as possible. However, this means that, in highly simplified fashion, the actual process can be implemented and/or conditioned in a manner which is restricted to the essential aspects and is decoupled from various parameter specifications, in particular cell-related and/or environment-related and/or safety related specifications, and thus can be modified and/or changed as desired and can thus be flexible even when the working environment or working cell remains virtually the same.

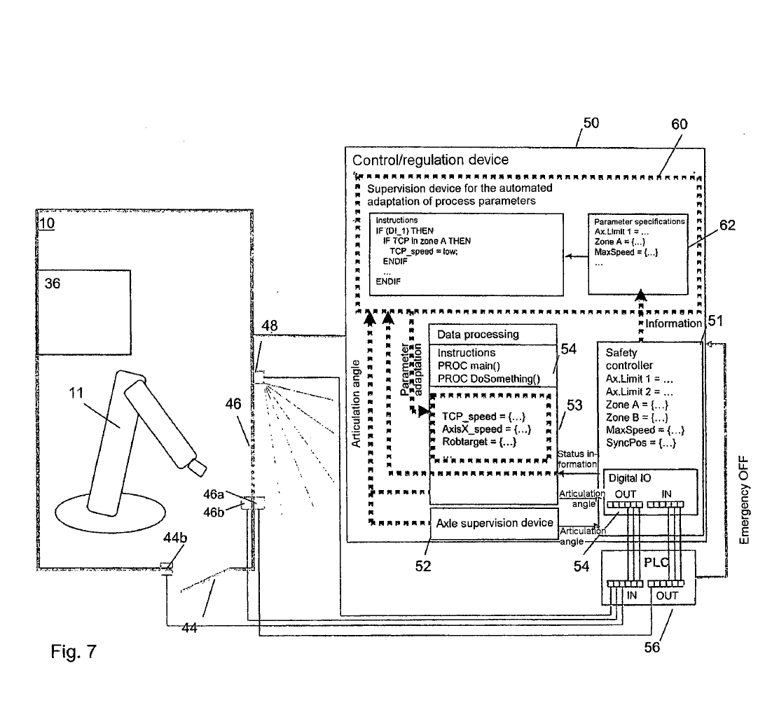

A system which is designed by way of example for the automated adaptation of process parameters of at least one handling device 11 is shown in FIG. 7 as part of a process controller for implementing the working process essentially known from FIG. 2 using a working cell 10 with a handling device 11, workpiece machining 36, a door 44 with a switch 44b, a roller door 46 with a drive 46a with a switch 46b and a laser scanner 48 for monitoring the environment thereof.

The process controller used comprises a control/regulation device 50 with a security controller 51 as well as an axle supervision device 52 for detecting and supervising the articulation angle, the axle and/or tool position and/or the alignment of at least one handling device 11. The control/regulation device 50 also comprises a data processing device 53 which, in interaction with a data memory (not explicitly illustrated in FIG. 4), transmits predetermined instructions 54 for carrying out and implementing the respective working process 38 to the handling device 11. In interaction with the data processing device 53 and the axle supervision device 52, the respective articulation and/or axle angles determined using the data processing device 53 and the axle supervision device 52 are compared with one another and/or matched to one another at predetermined synchronization positions using the safety controller 51, and the respective position and alignment of the handling device 11 are thus checked and corrected, if necessary. If limit values of individual process parameters and/or process specifications and/or regulations, in particular safety-specific regulations, for particular areas and/or zones of the respective working environment, in particular the working cell 10, as specified by the safety controller 51, are exceeded (upper limits) or undershot (lower limits) in this case, the safety controller 51 initiates an emergency shutdown of the control/regulation device 50 or the handling device 11 in interaction with a programmable logic controller (PLC) 56. Furthermore, the PLC 56 can interact with different monitoring devices, for example limit switches and light barriers, in order to retrieve and evaluate additional ambient information. Depending on the specifications, an emergency shutdown can thus also be initiated, for example, when the door 44 to the working cell 10 is open, which can be detected by the switch 44b, or when a person is in the detection range of the laser scanner 48. Finally, in order to avoid a shutdown and nevertheless make it possible to configure the process in a flexible and/or variable and changeable manner, a system for the automated adaptation of process parameters of at least one handling device 11 is also provided, which system interacts with the control/regulation device 50 with a safety controller 51 for monitoring and/or controlling and/or regulating the at least one handling device 11 and is integrated in said device. The system comprises at least one supervision device 60 which selectively monitors at least one process parameter, for example the speed and/or the position and/or the articulation angle and/or the synchronization position, and/or, if necessary, in particular in the case of an imminent breach or an imminent violation of process specifications, for example limit values to be complied with, and/or safety regulations, adapts at least one process parameter of the at least one handling device 11 in an anticipatory manner in automated fashion on the basis of specifications and/or the environment and/or in a rule-based manner in interaction with the at least one control/regulation device 50, environment-specific and/or safety-specific specifications and/or regulations also being complied with and/or implemented irrespective of the type of the respective working process. The interaction between the control/regulation device 50 and the supervision device 60 essentially involves adapted parameter values, in particular in the form of corresponding instructions, being transmitted to and/or impressed on the data processing device 53 of the control/regulation device 50 in order to be implemented for the process. In addition, during access, in particular read access, to the safety controller 51 and/or the axle supervision device 52, the supervision device 60 thus also monitors and/or detects parameter specifications 62 and/or regulations and/or ambient conditions which are recorded in the safety controller 51 and, in addition to the cell design, may also comprise sensor and/or monitoring and process parameters and status information of the at least one handling device 11 but also of operating means used. In this case, the monitoring can be carried out continuously, with the result that change information may also be immediately detected and recorded. When accessing the data processing device 53 and the axle supervision device 52, the supervision device 60 monitors and/or detects, in particular, articulation angles and/or angles of rotation and/or axle positions of at least one handling device 11 or a tool. This makes it possible for the supervision device 60 to supervise the movement and/or position of at least one handling device 11. With knowledge of the position and/or movement of the at least one handling device 11 as well as status/ambient information and/or process parameters and/or parameter specifications, the supervision device 60 is able to detect possible conflicts, in particular imminent violation or disregard of parameter specifications and/or regulations, and to adapt the affected parameter well in advance in interaction with the control/regulation device 50, that is to say to determine at least one corresponding correction instruction and/or instruction or at least one corresponding correction value and to transmit it/them to the control/regulation device 50, in particular the data processing device 53 of the latter, for implementation, to the effect that the imminent conflict and ultimately a shutdown or process interruption are avoided.

In addition, it is also conceivable to use a plurality of handling devices 11 inside a working environment or working cell, in which case status information, in particular position and/or movement information, as well as process specifications and/or regulations with regard to the respective other handling devices then also additionally have to be taken into account and/or detected and/or processed when adapting parameters. In order to keep the working or processing complexity for an individual supervision device 60 within limits and to restrict it, a plurality of supervision devices 60 could also be advantageously provided according to the system, for example a respective supervision device 60 for each handling device 11 used in the process, which supervision devices interact both with one another and with the control/regulation device 50.

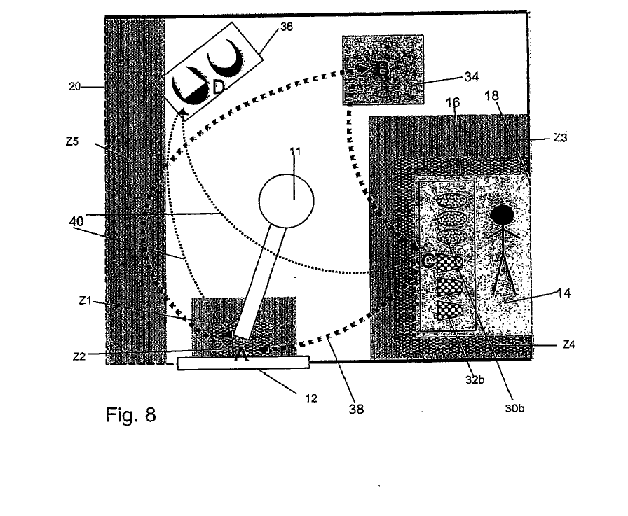

FIG. 8 shows an exemplary process sequence according to a method for the automated adaptation of process parameters of at least one handling device.

In this case, a process controller according to FIG. 7 with a system for the automated adaptation of process parameters of at least one handling device 11 is used for execution.

The method is based on a working cell 10 according to FIG. 2 including the corresponding process specifications and/or regulations, in particular safety-related specifications and/or regulations. The instructions from the control/regulation device 50 and/or data processing device 53 for the respective handling device 11 which are required to actually implement the process according to FIG. 2 and are in the form of program code means and thus also the actual process architecture are considerably simplified and reduced in comparison with the example according to FIG. 5 and, as explained below, are restricted only to fundamental process actions and instructions such as movement from point 1 to point 2, picking up or depositing a workpiece, machining a workpiece as well as opening or closing a gate and the like. Advanced parameter specifications, in particular safety-related specifications, and the actual working environment and/or respective cell design are not taken into account and/or included. The actual process actions are therefore decoupled from the respective working environment or cell design.

Exemplary instructions from the data processing device 53 for carrying out the process are as follows:

//Initial state: robot at A, gate open
WHILE true DO
pick up work piece;
close gate;
move to B;
process work piece;
move to C;
put down work piece;
IF next work piece NOT same as current
move to D;
change tool;
ENDIF
move to A;
open gate;
ENDWHILE.

According to the abovementioned instructions, the above-described process has the following pattern of action:

The process starts at station A if the gate 12, in particular a roller door, is open. If the handling device 11, in particular the robot, is at the starting point A and the door is open (starting situation), a first workpiece 30a is picked up, the gate 12 is then closed, the handling device 11 then moves from station A to B, the workpiece which has been picked up is machined in station B, a movement from station B to C is carried out with the machined workpiece 30b after machining, and the workpiece 30b is deposited at station C. Before the next workpiece 30a, 32a can now be picked up, it is necessary to check whether or not the subsequent workpiece corresponds to the previous workpiece; two alternatives therefore result.

1. The next, second workpiece 32a to be handled differs from the previous first workpiece 30a, with the result that a tool change is first of all required in order to handle said second workpiece. The handling device 11 therefore first of all moves from station C to D and carries out a tool change.

2. The next, second workpiece 30a to be handled is identical to the previous workpiece, with the result that no tool change is required in order to handle said second workpiece.

Starting from station D or C, the handling device 11 now moves back to the starting point A and opens the gate 12 in order to pick up the next workpiece 30a, 30b, for example.

Further details, for example relating to the different zones Z1 to Z5 and the speeds permitted therein, are no longer required and/or taken into account at this point by the control/regulation device 50 or the data processing device 53 of the latter in order to carry out the process.

Such process and/or parameter specifications and the compliance therewith are now the responsibility of the corresponding system for the automated adaptation of process parameters and, in particular, the supervision device 60 of said system, which supervision device adapts the respective process parameters in an anticipatory manner in automated fashion in interaction with the control/regulation device 50 of the handling device 11 and/or the respective process in such a manner that, in particular, the speed specifications and/or holding positions for the different zones are taken into account and complied with.

The instructions and/or control loops which are used by way of example to adapt the speed and are in the form of program code means are as follows:

- first control loop
//Standstill supervision
IF robot in area Z2

IF gate open

set speed = stop;

ELSE

set speed = slow;

ENDIF

ENDIF
-second control loop
//Supervise if worker enters
IF robot in area Z4

IF worker present

set speed = stop;

ELSE

set speed = slow;

ENDIF

ENDIF
- third control loop
//Slow speed area supervision
IF robot in area Z5 OR robot in area Z1 OR robot in area Z3

set speed = slow;

ELSE

set speed = high;

ENDIF

The first control loop contains the instructions that, if the handling device 11 is in zone Z2, it should remain or stop if the gate 12 is open. However, if the gate is closed, it should move in zone Z2 at a slow speed.

The second control loop comprises the instruction that, if the handling device is in zone Z4, it should remain or stop if a person is in the manual working area 14, which can be detected by the different light curtains and/or light barriers. If no person is present, it should move in zone Z4 at a slow speed.

The third control loop comprises the instruction that the handling device 11 should move at a slow speed in the zone Z5, Z1 or Z3 and should, for the rest, move at a fast speed.

The compliance with and/or setting of the speed of the handling device 11, as required for the different zones under certain conditions, or else a stop of the handling device is therefore effected, according to the method, by the system for the automated adaptation of process parameters and/or the supervision device 60 of said system in interaction with the control/regulation device 50 of the process and/or the handling device 11.

In this case, the working cell design and the process specifications specified on the basis of the design are taken into account and/or the relevant process parameters are detected and/or monitored continuously and/or on the basis of position.

The actual process or process sequence can be redesigned and/or changed in a simple manner as a result of the fact that the actual process is decoupled from the respective working environment, in particular the respective cell, and the associated parameter specifications and/or safety regulations.

This makes it possible to alternately carry out different processes in the same working environment or the same working cell with comparatively little effort.

1-22. (canceled)

23. A system for automated adaption of a process parameter of a handling device comprising:
a supervision device configured to selectively monitor at least one process parameter and/or to adapt the at least one process parameter of the handling device in an automated manner based on specifications and/or the environment and/or in a rule-based manner in interaction with a control/regulation device, wherein environment/safety-specific specifications and/or regulations are complied with and/or implemented irrespective of the type of a respective working process, wherein the system is configured to interact with the control/regulation device configured to monitor, control and/or regulate the handling device.

24. The system as recited in claim 23, wherein the at least one process parameter is adapted in an anticipatory manner.

25. The system as recited in claim 23, further comprising an interface configured to detect and/or determine ambient information.

26. The system as recited in claim 23, wherein the supervision device is provided with and/or based on a respective working environment so as to adapt parameters.

27. The system as recited in claim 23, wherein the at least one process parameter is adapted based on at least one of a position, an alignment, and a tool of the handling device.

28. The system as recited in claim 23, wherein the at least one process parameter is adapted on a basis of and/or configured to take into account a position, an alignment, and/or a speed of at least one other handling device when a plurality of handling devices are used.

29. The system as recited in claim 23, further comprising at least one further interface configured to enable predetermined process information to be detected by and/or transmitted to the control/regulation device.

30. The system as recited in claim 29, wherein the at least one further interface is wireless, wired and/or in the form of a field bus interface.

31. The system as recited in claim 23, wherein the supervision device is configured to detect position information for the handling device continuously, cyclically or continuously in recurring intervals of time, and configured to evaluate the position information and to determine and/or adapt parameters based on the position information.

32. The system as recited in claim 23, wherein the position information can be detected in an interaction with the control/regulation device and/or a safety controller.

33. The system as recited in claim 23, further comprising a data memory configured to store process/ambient information and/or instructions for the control/regulation device and the supervision device such that the process/ambient information and/or the instructions can be retrieved and/or executed.

34. The system as recited in claim 33, wherein the control/regulation device includes a data processing device configured to interact with the data memory including process information and/or instructions configured to carry out and/or implement the respective working process.

35. The system as recited in claim 23, wherein the supervision device can be integrated in the control/regulation device.

36. The system as recited in claim 33, wherein the instructions and/or a movement pattern are determined solely by the respective working process and/or do not comprise any environment-specific specifications and/or take into account any environment-specific specifications.

37. The system as recited in claim 23, wherein the supervision device is configured to dynamically adapt the at least one process parameter in the case of changing ambient conditions.

38. The system as recited in claim 23, wherein an adaptation of the at least one process parameter and a resulting change from an actual value to a desired value are effected on a basis of the environment and/or specifications using a continuous function.

39. The system as recited in claim 23, wherein the supervision device can adapt a speed, at least one speed component, an orientation, an alignment, and/or a position as the at least one process parameter of the handling device and/or a tool of the handling device.

40. The system as recited in claim 23, wherein the supervision device is configured to adapt the at least one process parameter online and/or in real time during a continuous operation of the handling device during a respective process execution.

41. The system as recited in claim 23, further comprising a safety controller configured to effect an emergency shutdown of the process if a predetermined safety rule is violated and/or there is a deviation from a parameter specification outside permissible limit values, wherein the supervision device and the safety controller are configured to act independently of and not influence one another.

42. The system as recited in claim 23, wherein the handling device includes an industrial robot having a plurality of axles and/or articulations.

43. The system as recited in claim 23, wherein the supervision device includes a data processing device.

44. A process controller for controlling/regulating a handling device for carrying out a working process comprising:
a control/regulation device;
a safety controller; and
a system for automated adaption of a process parameter of a handling device having a supervision device configured to selectively monitor at least one process parameter and/or to adapt the at least one process parameter of the handling device in an automated manner based on specifications and/or the environment and/or in a rule-based manner in interaction with the control/regulation device, wherein environment/safety-specific specifications and/or regulations are complied with and/or implemented irrespective of the type of a respective working process, wherein the system is configured to interact with the control/regulation device configured to monitor, control and/or regulate the handling device.
